(19) United States
(12) Patent Application Publication
(10) Pub. No.: US 2011/0107432 A1
(43) Pub. Date: May 5, 2011

(54) COMPUTER READABLE MEDIUM STORING INFORMATION PROCESSING PROGRAM, INFORMATION PROCESSING APPARATUS AND INFORMATION PROCESSING SYSTEM

(75) Inventor: Satoshi Oomori, Kawasaki-shi (JP)

(73) Assignee: FUJI XEROX CO., LTD., TOKYO (JP)

(21) Appl. No.: 12/781,443

(22) Filed: May 17, 2010

(30) Foreign Application Priority Data
Nov. 4, 2009 (JP) 2009-252636

(51) Int. Cl. G06F 21/00

(52) U.S. Cl. 726/27

(57) ABSTRACT

A computer readable medium storing a program causing a computer to execute a process for information processing includes: reading, from a storage unit, setting information used in processing performed by an apparatus and prohibited matter information including at least a setting to avoid a prohibited matter at setting in the apparatus; and extracting a setting to avoid the prohibited matter changeable regarding at least a part of restricted setting information in the setting information read at the reading step, and making a setting not to perform the extracted setting.

### CROSS-REFERENCE TO RELATED APPLICATIONS

This application is based on and claims priority under 35 USC 119 from Japanese Patent Application No. 2009-252636 filed Nov. 4, 2009.

### BACKGROUND

1. Technical Field

The present invention relates to a computer readable medium storing an information processing program, an information processing apparatus and an information processing system.

2. Related Art

For transmission of image information to be print-outputted from a computer to an image forming apparatus (for example, a printer or a copier), condition setting software executed on the computer, i.e., a printer driver, is used. The printer driver performs processing to receive inputs of setting values of print conditions and setting items and send the conditions and settings, with the image information, to the image forming apparatus.

Note that to meet users' requirements to prohibit use of some of various functions of the printer driver, or to forcibly designate some of settings, there is software (customize tool) to change initial values (default values) of some of settings, to forcibly designate some of functional settings, or to generate the above-described customized driver. The customize tool has a function to fix functional settings of a printer driver such as double-sided printing and security printing with certain values.

### SUMMARY

According to an aspect of the present invention, there is provided a computer readable medium storing a program causing a computer to execute a process for information processing, the process including: reading, from a storage unit, setting information used in processing performed by an apparatus and prohibited matter information including at least a setting to avoid a prohibited matter at setting in the apparatus; and extracting a setting to avoid the prohibited matter changeable regarding at least some of restricted setting information in the setting information read at the reading step, and making a setting not to perform the extracted setting.

### BRIEF DESCRIPTION OF THE DRAWINGS

An exemplary embodiment of the present invention will be described in detail based on the following figures, wherein:

FIG. 1 illustrates an application of an information processing apparatus according to a present exemplary embodiment;

FIG. 2 is a screen display example upon execution of a program as the information processing apparatus;

FIG. 3 is a screen display example when an initial value setting is selected;

FIG. 4 is a screen display example when user operation restriction is selected;

FIG. 5 is an example of information showing combinations of setting items and conditions;

FIG. 6 is a block diagram showing a configuration of the information processing apparatus according to the present exemplary embodiment;

FIG. 7 is a table explaining rewriting of combinations of information;

FIG. 8 is a block diagram showing another configuration (part 1) of the information processing apparatus according to the present exemplary embodiment;

FIG. 9 is a block diagram showing another configuration (part 2) of the information processing apparatus according to the present exemplary embodiment;

FIG. 10 illustrates a configuration of an information processing system according to the present exemplary embodiment;

FIG. 11 is a flowchart showing an information processing program according to the present exemplary embodiment;

FIG. 12 is a table explaining another example (part 1) of prohibited matter information;

FIG. 13 is a table explaining the other example (part 1) of the prohibited matter information;

FIG. 14 is a table explaining another example (part 2) of the prohibited matter information;

FIG. 15 is a table explaining the other example (part 2) of the prohibited matter information;

FIG. 16 is a table explaining another example (part 3) of the prohibited matter information; and

FIG. 17 is a table explaining the other example (part 3) of the prohibited matter information.

### DETAILED DESCRIPTION

Hereinbelow, an exemplary embodiment of the present invention will be described. Note that the explanation will be made in the following order.

1. Information processing apparatus
2. Information processing system
3. Information processing program
4. Other examples of prohibited matter information

### <1. Information Processing Apparatus>

### [Application of Information Processing Apparatus According To Present Exemplary Embodiment]

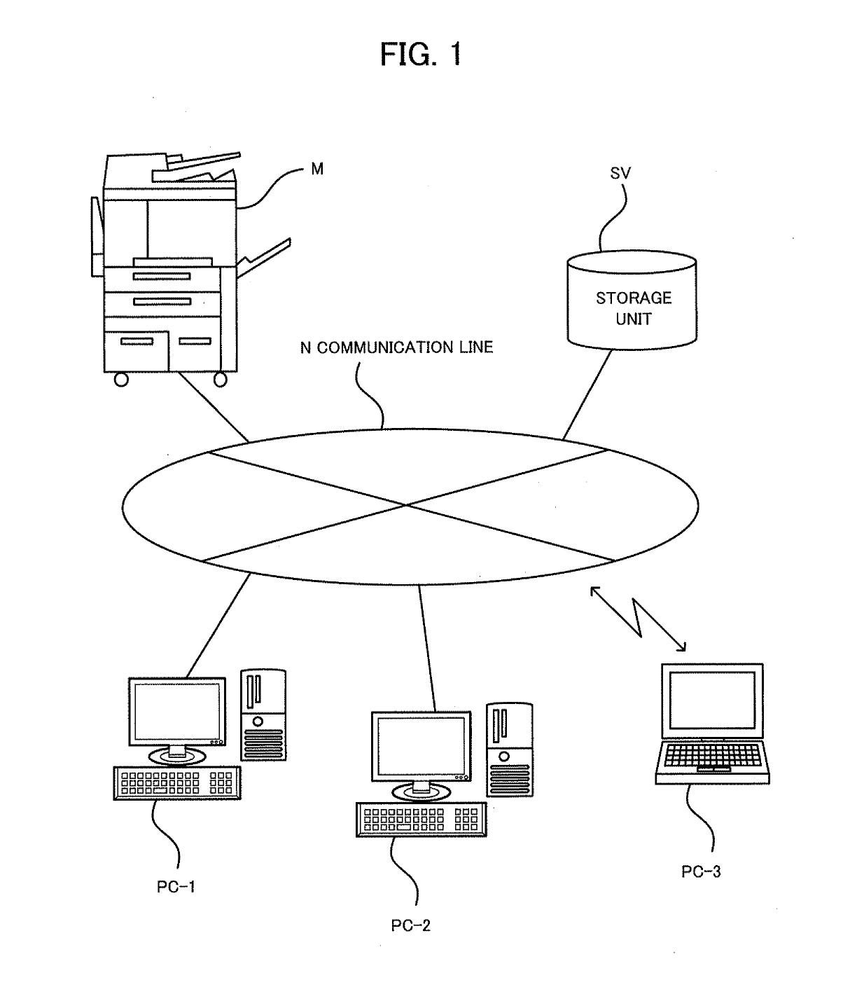

FIG. 1 illustrates an application of an information processing apparatus according to a present exemplary embodiment. The information processing apparatus according to the present exemplary embodiment is realized with a program executed on a computer PC (personal computer and the like). The information processing apparatus has a function to rewrite condition setting software (hereinbelow, “printer driver”) used for execution of various processing in the image processing apparatus.

As the image processing apparatus, a copier, a printing apparatus (printer), an image input device (scanner), a facsimile apparatus, a multi-function peripheral (a machine having plural functions such as a copying function, a print function, an image input function and a facsimile function) can be used. In the present exemplary embodiment, a multi-function peripheral M is used as the information processing apparatus.

The information processing apparatus in the present exemplary embodiment has a function (customize function) to rewrite a printer driver, executed on a computer (for example, a computer PC-1) and used on another computer PC-2 or PC-3, in correspondence with a user's usage.

In the application shown in FIG. 1, plural computers (PC-1 to PC-3 in FIG. 1) are connected via a communication line N. The communication line N is a LAN (Local Area Network) or a WAN (Wide Area Network). The communication line N and the computers are connected via a cable or wireless communication.

Further, the multi-function peripheral M and a storage unit SV are connected to the communication line N. The storage unit SV functions as a delivery originator (server) of various information. The storage unit SV delivers information in correspondence with a request from the computer PC via the communication line N to the requester computer PC, or stores information sent via the communication line N in correspondence with a request from the multi-function peripheral M or the computer PC.

Further, the storage unit SV also stores a printer driver applied to the multi-function peripheral M, and delivers the printer driver to the computer PC in accordance with necessity. The storage unit SV may be independently connected to the communication line N or may be connected to the communication line N via the computer PC.

In this configuration, the information processing apparatus in the present exemplary embodiment reads a printer driver, executed on the computer (for example, the computer PC-1) and subjected to rewriting, from the storage unit SV, performs predetermined rewriting to construct a new printer driver (customized printer driver), and stores the new printer driver into the storage unit SV or delivers it to another computer (for example, the computer PC-2 or PC-3).

In image processing with the multi-function peripheral M in accordance with an instruction from the computer PC, the printer driver performs condition designation such as designation of an original size, an output paper size, the number of copies in image processing, single-sided/double-sided printing, the number of pages laid out in one sheet (so-called N-up), a color mode (monochrome/color), a discharge tray, image processing (color tint, gradation processing and the like) on the computer PC side.

The items and contents of the conditions which can be set with this printer driver are determined based on the functions of the multi-function peripheral M and a user's authority. In determination of the items and contents, the information processing apparatus in the present exemplary embodiment is applied.

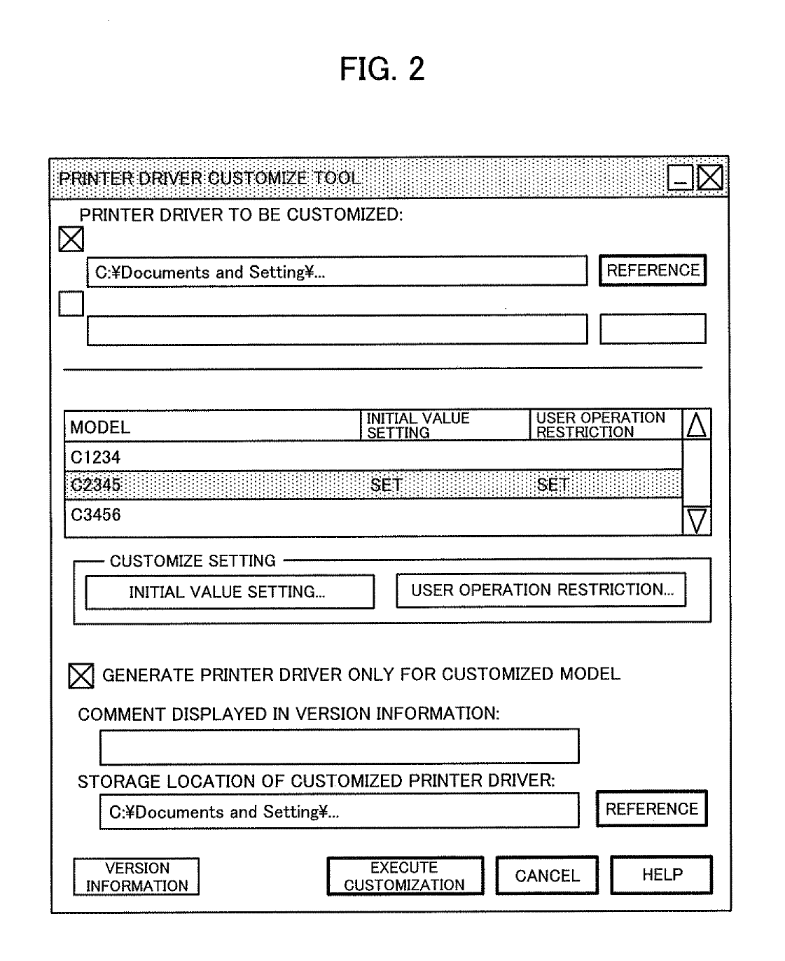

FIG. 2 is a screen display example upon execution of a program as the information processing apparatus. The program to realize the information processing apparatus is expressed as a customize tool for the printer driver. When the customize tool is executed, a field to designate a printer driver to be customized (printer driver to be rewritten) is displayed in an upper part of the screen display so as to designate the file of the printer driver to be rewritten. The user selects a “reference” key in accordance with necessity, and designates the file of the printer driver to be rewritten.

In an intermediate part of the screen display, a field to select a model name is displayed. In this field, a list of model names to be controlled with the printer driver to be rewritten is displayed. The user selects a corresponding model name from the list. The selected model name is displayed in a style different from that of other model names. Further, in this field, the state of initial value setting and restriction of user operation are displayed by model name. When the initial value setting has been performed, “set” is displayed, and when the user operation restriction has been made, “set” is displayed.

Below the display of the list of model names, keys of customize setting items are displayed. To perform the initial value setting, an “initial value setting” key, and to perform user operation restriction, a “user operation restriction” key are selected. When these keys are selected, another screen display is produced, and respective settings are made.

In a lower part of the screen display, there is a check box to select whether or not a printer driver is generated only for the model regarding which the customize setting has been made. When a printer driver is generated for all the models, the check in the check box is deleted.

Further, below the check box, a comment input field to be displayed in version information, and a field to designate a storage location of the printer driver after execution of customization are displayed. In the lowest part of the screen display, a “version information” key, an “execute customization” key, a “cancel” key, and a “help” key are displayed.

When the “version information” key is selected, version information and comments of the selected printer driver are displayed on the screen. When the “execute customization” key is selected, generation of a new printer driver reflecting the conditions of the items set in the customization is performed. When the “cancel” key is selected, the processing ends without reflecting the settings so far customized. When the “help” key is selected, operation guidance is displayed.

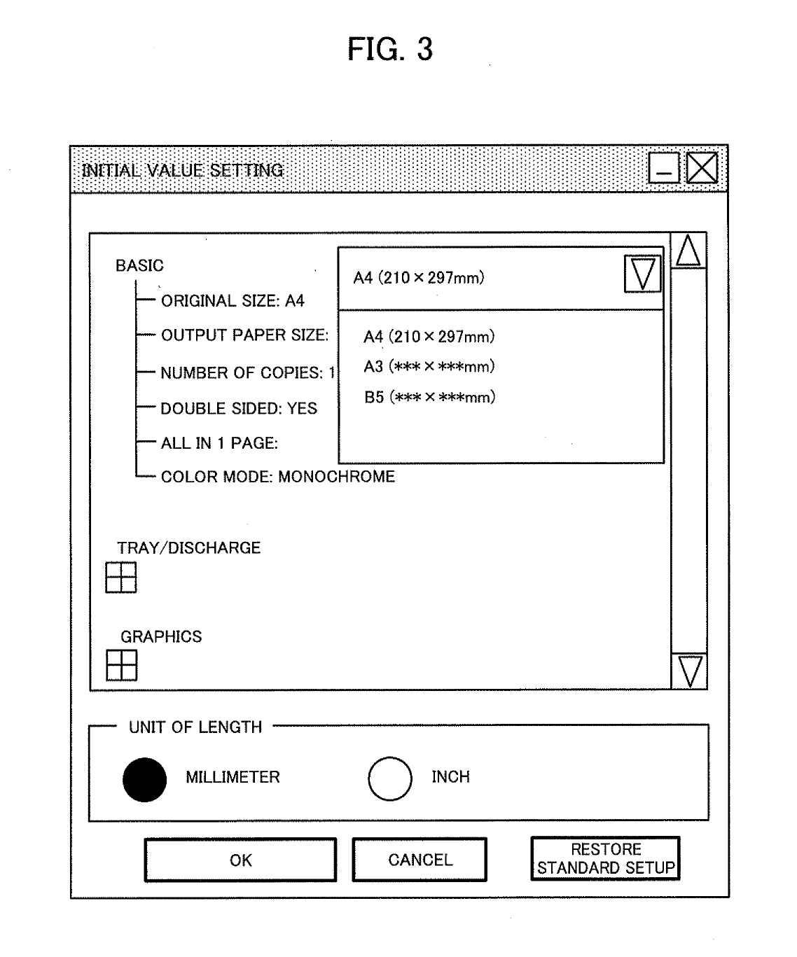

FIG. 3 is a screen display example when initial value setting is selected. This screen display example is produced when the “initial value setting” key as the customize setting in the intermediate field in the screen display example shown in FIG. 2 is selected. In this screen display, as initial value setting, basic setting, tray setting, graphics setting and the like are hierarchically displayed. The user selects a desired setting item in this screen display. By this operation, the setting condition of the selected item is displayed as another screen. For example, when the “original size” item is selected, various original size setting examples are displayed in an another screen. The user selects an original size to be set as an initial value from this screen.

After the desired initial value setting, when an “OK” key in a lower part of the screen display is selected, the initial value of the set item is registered. Further, when a “cancel” key is selected, the processing ends without reflecting the set initial value. Further, when a “restore standard setup” key is selected, standard conditions previously set regarding all the items of the printer driver are restored.

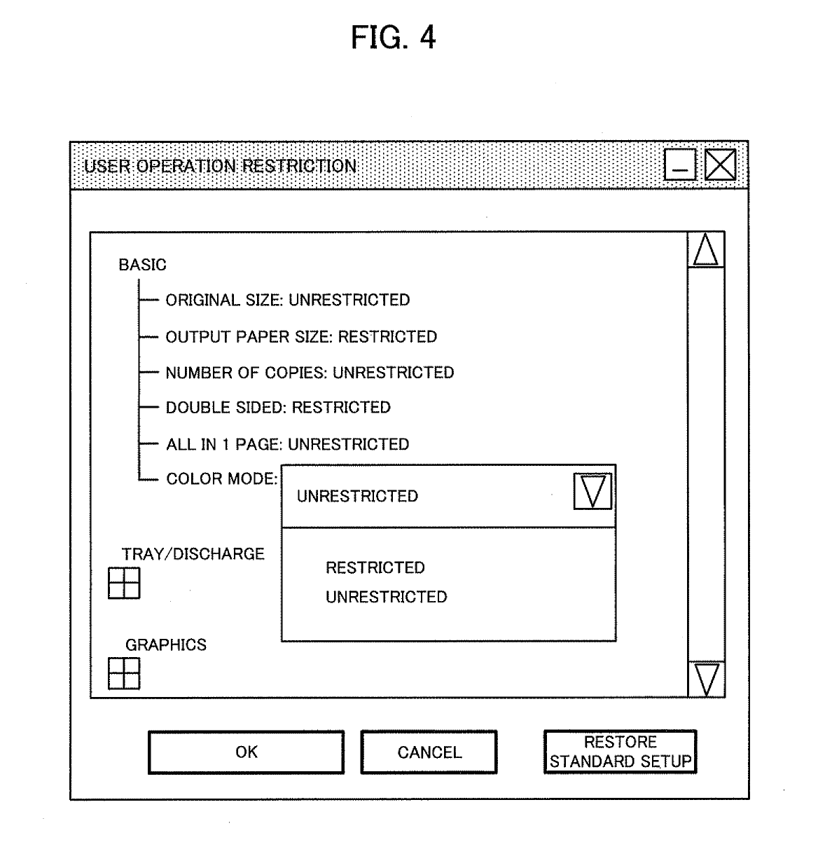

FIG. 4 is a screen display example when user operation restriction is selected. This screen display example is produced when the “user operation restriction” key in the customize setting in the intermediate field of the screen display example shown in FIG. 2 is selected. In this screen display, as the user operation restriction, basic setting, tray setting, graphics setting and the like are hierarchically displayed. The user selects a desired setting item in this screen display. By this operation, the setting of the user operation restriction of the selected item is displayed as another screen. For example, when a “color mode” item is selected, a screen to select whether or not user operation regarding the color mode is restricted is displayed. The user selects whether or not user operation is to be restricted from this screen.

After the setting of the user operation restriction, when an “OK” key in a lower part of the screen display is selected, the set condition of the item is registered. Further, when a “cancel” key is selected, the process ends without reflecting the set condition. Further, when a “restore standard setup” key is selected, standard conditions previously set regarding all the items of this printer driver are restored.

### [Comparative Example of Information Processing Apparatus]

Next, a comparative example of the information processing apparatus in the present exemplary embodiment will be described. As in the case of the information processing apparatus in the present exemplary embodiment, the information processing in the comparative example is realized with program processing performed on a computer (e.g. the computer PC-1) and has a function (customize tool) to rewrite a printer driver.

The information processing apparatus in the comparative example first reads information indicating conditions of setting items for the printer driver to be rewritten. The information indicating the conditions of the setting items corresponds to information to store the above-described conditions of various items set with the customize tool. When the conditions are rewritten and the “execute customization” key shown in FIG. 2 is selected, the information indicating the rewritten conditions is stored.

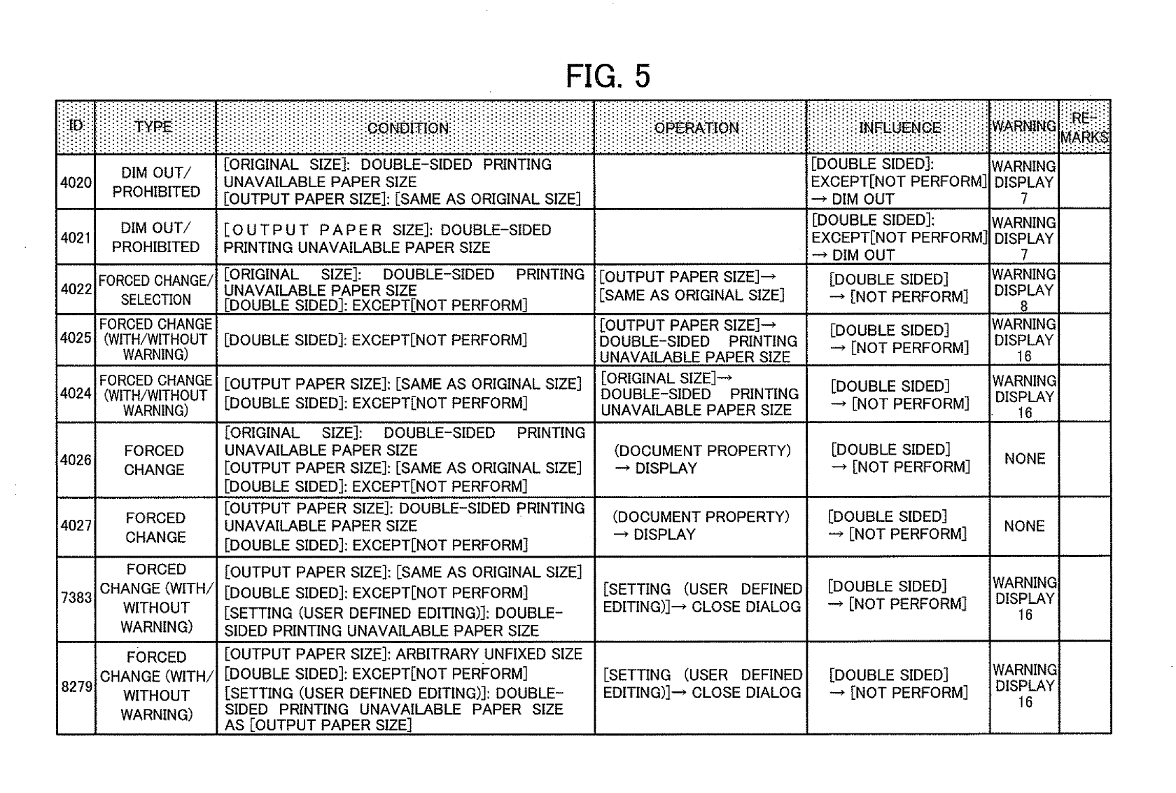

FIG. 5 is an example of prohibited matter information as combinations of setting items and conditions. FIG. 5 shows a state where “type”, “condition”, “operation”, “influence” and “warning” correspond to one ID (identification code). The operation shown with the “type” is an operation in a state where a condition (condition item of prohibited matter information) indicated with the same ID of the type is set and when an operation indicated with the ID is performed by the user. Further, the item “influence” shows how the content of the item is changed in correspondence with the operation indicated with the type.

For example, the ID 4024 shows information that, as the conditions of the setting items of the printer driver, in a state where the “output paper size” is set to “same as original size” and the “double sided” printing is set to “printing except ‘not perform’” (that is, only double-sided printing can be performed), when a double-sided printing unavailable paper size is designated as the “original size” as the user's operation, the “double sided” printing setting is forcibly changed to “not perform” “double sided” printing. The printer driver refers to the prohibited matter information and performs an operation of a type corresponding to the condition and the operation.

The prohibited matter information shown in FIG. 5 shows types based on combinations between the conditions and operations of “original size”, the “output paper size” and the “double sided”; however, the prohibited matter information in this figure is merely an example and type information based on conditions between various conditions and operations can be applied.

In the comparative example, the above-described information is generated by the information processing apparatus (customize tool). The printer driver refers to this information and determines an operation. When the prohibited matter information shown in FIG. 5 is generated by the information processing apparatus in the comparative example, the conditions of the items as initial setting might be forcibly changed in accordance with the user's operation.

For example, in the ID 4024 shown in FIG. 5, the “double sided” printing is set to printing “except ‘not perform’” as the condition. That is, a printer driver having initial values customized by the customize tool to prohibit single-sided printing (allow only double-sided printing) and perform printing in a size “same as original size” as the “output paper size” is generated. More particularly, in a user interface of the printer driver, only the “double sided” printing is displayed and other printing than the double-sided printing is displayed in a dimmed out state or the like and cannot be selected.

However, when the user uses the printer driver and selects a paper size unavailable in double-sided printing as the “output paper size” in accordance with the prohibited matter information (see FIG. 5), “double sided” printing is forcibly changed to “not perform” “double sided” printing.

That is, an item which cannot be selected by dim out display or the like is forcibly changed such that it can be selected by the user's setting of another item. Accordingly, in customization using the customize tool, not only restriction not to select single-sided printing (only “double sided” printing) but also restriction not to select “double-sided printing unavailable paper size” in the “output paper size” are required. Accordingly, it is necessary for the user to sufficiently grasp prohibited matter information to customize the printer driver.

In this manner, even when initial conditions are set for predetermined items, there are so many combinations to be changed by the user's designating conditions of other items. It is difficult even for a person who sets prohibited matter information condition items utilizing the customize tool to grasp the prohibited matter information.

### [Configuration of Information Processing Apparatus According to Present Exemplary Embodiment]

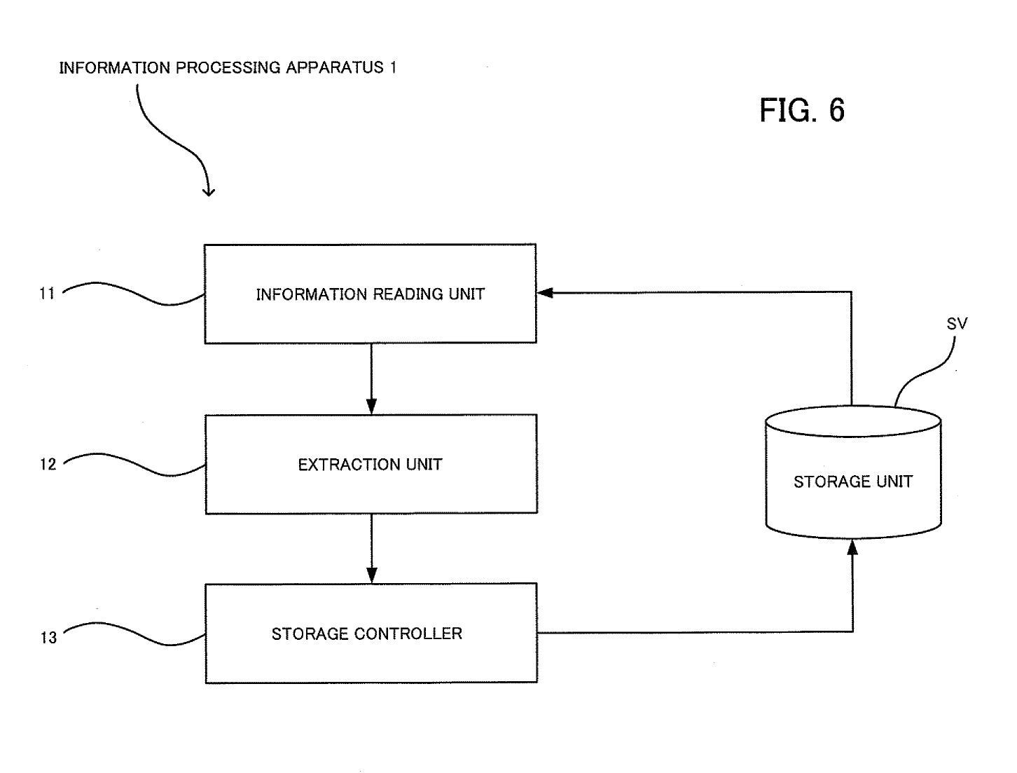

FIG. 6 is a block diagram showing a configuration of the information processing apparatus according to the present exemplary embodiment. An information processing apparatus 1 according to the present exemplary embodiment has an information reading unit 11, an extraction unit 12 and a storage controller 13. These units are realized by program processing performed on a computer (for example, the computer PC-1 shown in FIG. 1).

The information reading unit 11 performs processing to read setting information used in processing performed by the apparatus and the prohibited matter information (see FIG. 5) including at least a setting to avoid prohibited matter upon setting in the apparatus, from the storage unit SV. Note that the prohibited matter information may be stored in the storage unit SV, or may be held as an element of the printer driver itself. At this time, the information reading unit 11 performs processing to read the prohibited matter information held in the printer driver.

The extraction unit 12 performs processing to extract a setting to avoid a prohibited matter regarding which at least some of restricted setting information in the setting information read by the information reading unit 11 might be changed. The storage controller 13 performs control to store information indicating that the setting extracted by the extraction unit 12 is not performed into the storage unit SV.

Screen display examples upon execution of the program as the information processing apparatus 1 according to the present exemplary embodiment are the same as those shown in FIGS. 2 to 4. That is, the program as the information processing apparatus 1 according to the present exemplary embodiment is executed as a customize tool for the printer driver. In the present exemplary embodiment, the difference from the comparative example is processing upon selection of customize setting in the intermediate part of the screen display by the user in a state where the customize tool is executed and the screen of the example shown in FIG. 2 is displayed.

When the user selects the “initial value setting” key in the customize setting of the screen display example shown in FIG. 2, the user sets the initial values in accordance with the screen display example shown in FIG. 3. Further, when the user selects the “user operation restriction” key, the user performs user operation restriction in accordance with the screen display example shown in FIG. 4. The screen displays and the user operations are not different from those in the comparative example; however, in the information processing apparatus 1 in the present exemplary embodiment, the difference from the comparative example is that the prohibited matter information shown in FIG. 5 is rewritten.

An example of rewriting of prohibited matter information performed by the information processing apparatus 1 in the present exemplary embodiment will be described. First, the information reading unit 11 reads prohibited matter information used by the printer driver to be rewritten from the storage unit SV.

Next, the extraction unit 12 extracts a combination which disables change of condition upon predetermined operation, from the prohibited matter information read by the information reading unit 11. As an extraction rule, the following rule, for example, can be given. That is, in the prohibited matter information shown in FIG. 5, an ID of information to change the item “double sided” displayed in the “influence” item to “not perform” is extracted. In this “influence” item, information of set condition which can be changed by the user's operation is shown. The extraction unit 12 performs extraction based on information of the “influence” item.

After the extraction by the extraction unit 12, the storage controller 13 performs control to rewrite the prohibited matter information and store the rewritten prohibited matter information into the storage unit SV. More particularly, in the item of the ID in the prohibited matter information extracted by the extraction unit 12, the content of the type is rewritten to an operation to disable the user's selection (for example, dim out or change-prohibited state).

As the subject of “type” rewriting, all the IDs extracted by the extraction unit 12 may be rewritten, or only ID(s) to perform a predetermined operation among the IDs extracted by the extraction unit 12 may be rewritten.

As the rule to rewrite the “type” of one of the extracted IDs, previously-provided information (rewriting subject information) is used. The storage controller 13 determines ID(s) of which the “type” is to be rewritten among the extracted IDs, based on the rewriting subject information. It may be arranged such that the rewriting subject information is changeable by the user (machine administrator or the like). Further, it may be arranged such that plural types of rewriting subject items are prepared selectively by a selection unit.

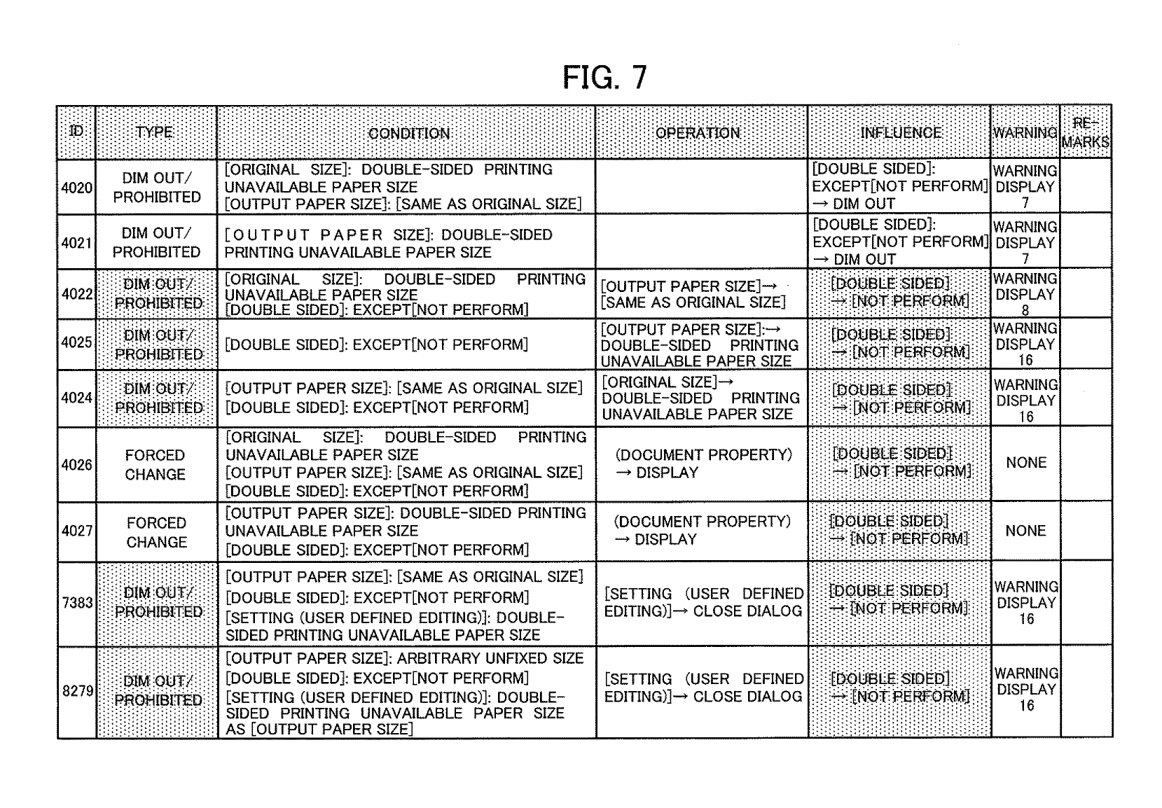

FIG. 7 is a table explaining rewriting of the prohibited matter information. FIG. 7 shows a state after rewriting of the prohibited matter information shown in FIG. 5. In the “influence” item shown in FIG. 7, IDs of information to “not perform” “double sided” printing are to be extracted. Among these IDs, the “type” of IDs with a predetermined operation is rewritten to “dim out/prohibited”. The type “dim out/prohibited” means disabling selection of setting change by the user on the screen regarding the “operation” item.

By this rewriting, on a previously set condition, when the user is to change the setting of another item, setting change to change the set condition cannot be performed.

For example, in the ID 4022 to be extracted, as the set condition, the “original size” is set to the “double-sided printing unavailable paper size”, and the “double sided” printing is set to “except ‘not perform’” (that is, only double-sided printing can be performed). In this state, when the user is to select “same as original size” as the “output original size”, the selection item “same as original size” in the screen display is dimmed out and is unselectable.

Further, in the ID 4025 to be extracted, as the set condition, the “double sided” printing is set to “except ‘not perform’”. In this state, when the user is to select a double-sided printing unavailable paper size as the “output original size”, the selection item of the double-sided printing unavailable paper size in the screen display is dimmed out and is unselectable.

Further, in the ID 4024 to be extracted, as the set condition, the “output paper size” is set to the “same as original size”, and the “double sided” printing is set to the “except ‘not perform’”. In this state, when the user is to select a double-sided printing unavailable paper size as the “original size”, the selection item of the double-sided printing unavailable paper size in the screen display is dimmed out and is unselectable.

Further, in the ID 7383 to be extracted, as the set condition, the output paper size” is set to the “same as original size”, the “double sided” printing is set to the “except ‘not perform’”, and the “setting (user defined editing)” is set to the double-sided printing unavailable paper size. In this state, when the user is to close the dialog (screen display) of the “setting (user defined editing)”, a key to close the dialog is dimmed out and is unselectable.

Further, in the ID 8279 to be extracted, as the set condition, the “output paper size” is set to an “arbitrary unfixed size”, the “double sided” printing is set to the “except ‘not perform’”, and the “setting (user defined editing)” is set to “double-sided printing unavailable paper size as ‘output paper size’”. In this state, when the user is to close the “setting (user defined editing)” dialog (screen display), the key to close the dialog is dimmed out and is unselectable.

Note that in addition to the dim out display of the selection item in the screen display regarding the item unselectable for the user, it may be arranged such that a warning (voice message or screen display) indicating that the item cannot be changed is outputted when the user is to select the item.

### [Another Configuration of Information Processing Apparatus According to Present Exemplary Embodiment (Part 1)]

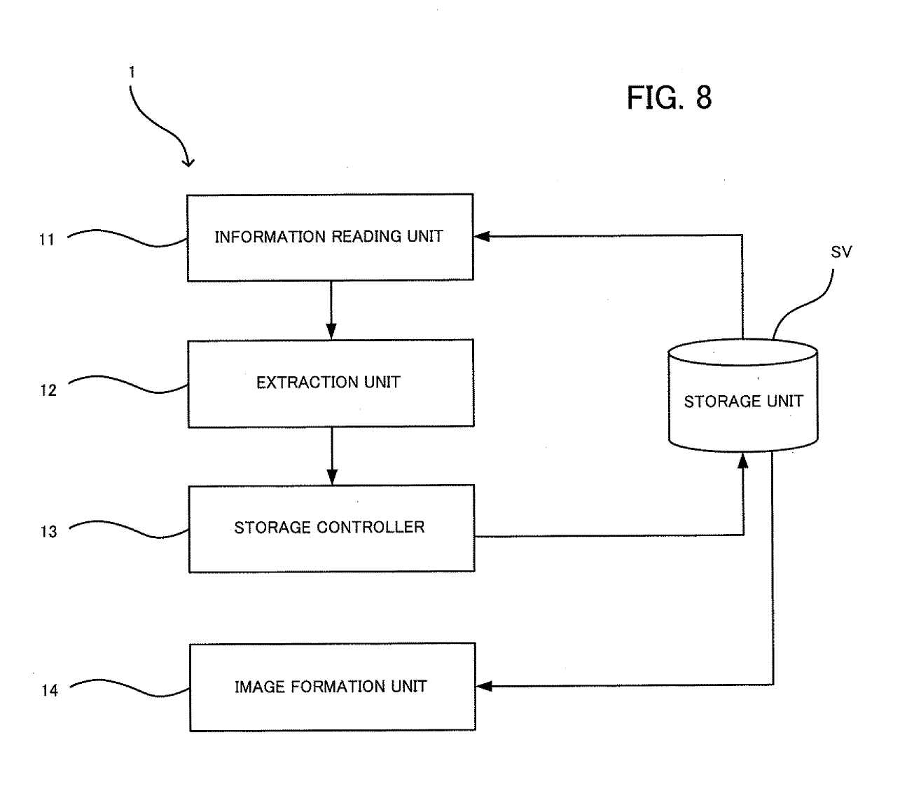

FIG. 8 is a block diagram showing another configuration (part 1) of the information processing apparatus according to the present exemplary embodiment. As in the case of the configuration shown in FIG. 6, the configuration of the information processing apparatus 1 has the information reading unit 11, the extraction unit 12, the storage controller 13, and further, an image forming unit 14.

The information reading unit 11 performs processing to read setting information used in processing performed by the apparatus and the prohibited matter information (see FIG. 5) including at least a setting to avoid prohibited matter at setting in the apparatus from the storage unit SV. The extraction unit 12 performs processing to extract a setting to avoid a prohibited matter regarding which at least some of restricted setting information in the setting information read by the information reading unit 11 might be changed. The storage controller 13 performs control to store information indicating that the setting extracted by the extraction unit 12 is not performed into the storage unit SV.

The image forming unit 14 forms an image on a medium using the setting information used in processing performed by the apparatus. That is, the information processing apparatus 1 having the configuration shown in FIG. 8 is constructed in an image forming apparatus such as a copier, a printing apparatus and a multi-function peripheral.

### [Another Configuration of Information Processing Apparatus According to Present Exemplary Embodiment (Part 2)

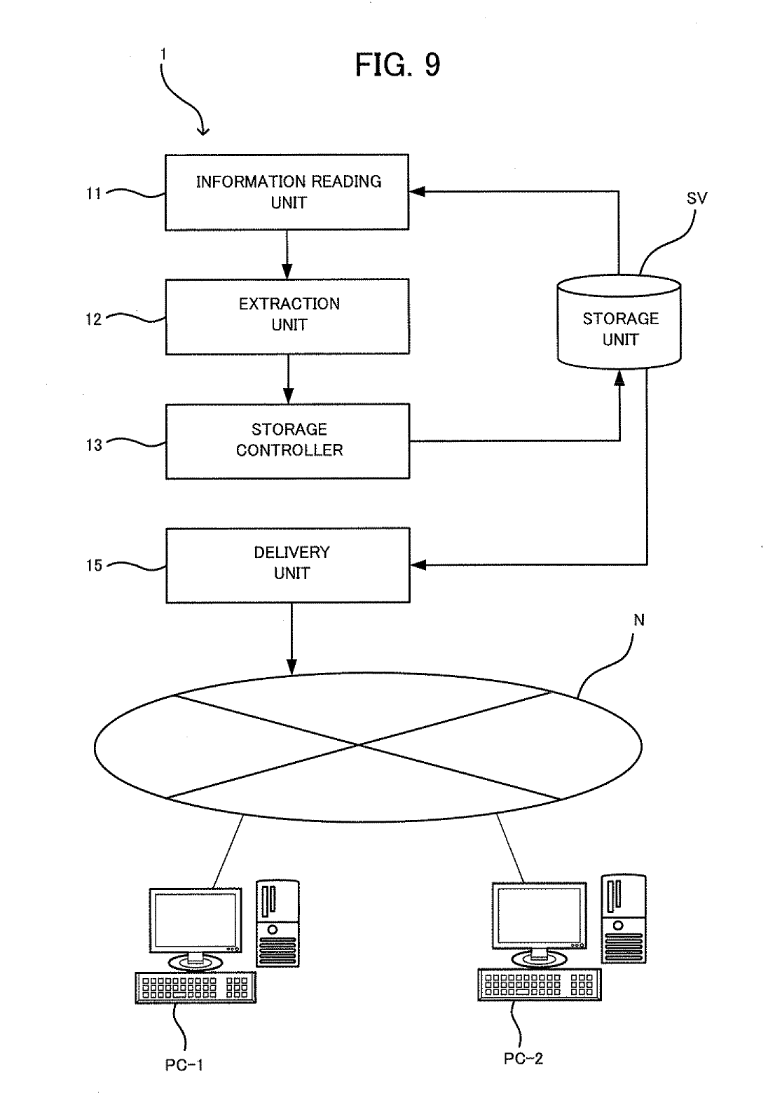

FIG. 9 is a block diagram showing another configuration (part 2) of the information processing apparatus according to the present exemplary embodiment. As in the case of the configuration shown in FIG. 6, the configuration of the information processing apparatus 1 has the information reading unit 11, the extraction unit 12, the storage controller 13, and further, a delivery unit 15.

The information reading unit 11 performs processing to read setting information used in processing performed by the apparatus and the prohibited matter information (see FIG. 5) including at least a setting to avoid a prohibited matter at setting in the apparatus from the storage unit SV. The extraction unit 12 performs processing to extract a setting to avoid a prohibited matter regarding which at least some of restricted setting information in the setting information read by the information reading unit 11 might be changed. The storage controller 13 performs control to store information indicating that the setting extracted by the extraction unit 12 is not performed into the storage unit SV.

The delivery unit 15 performs processing to deliver the setting information and the prohibited matter information stored in the storage unit SV via the communication line N to the computer (for example, the computer PC-1 or PC-2). That is, the information processing apparatus 1 having the configuration shown in FIG. 9 performs rewriting of prohibited matter information used by the printer driver with the above-described information reading unit 11, the extraction unit 12 and the controller 13. Further, in the information processing apparatus 1, the delivery unit 15 delivers the rewritten prohibited matter information stored in the storage unit SV and the printer driver using the rewritten prohibited matter information via the communication line N to the computer (for example, the computers PC-1 or PC-2).

The delivery unit 15 reads a printer driver and prohibited matter information from the storage unit SV in response to a request from the user received in the information processing apparatus 1, and delivers the read information via the communication line N to the computer PC-1 or PC-2. Further, the delivery unit 15 reads the printer driver and prohibited matter information from the storage unit SV in response to a request sent from the computer PC-1 or PC-2 via the communication line N, and delivers the read printer driver and prohibited matter information via the communication line N to the requester computer PC-1 or PC-2.

### <2. Information Processing System>

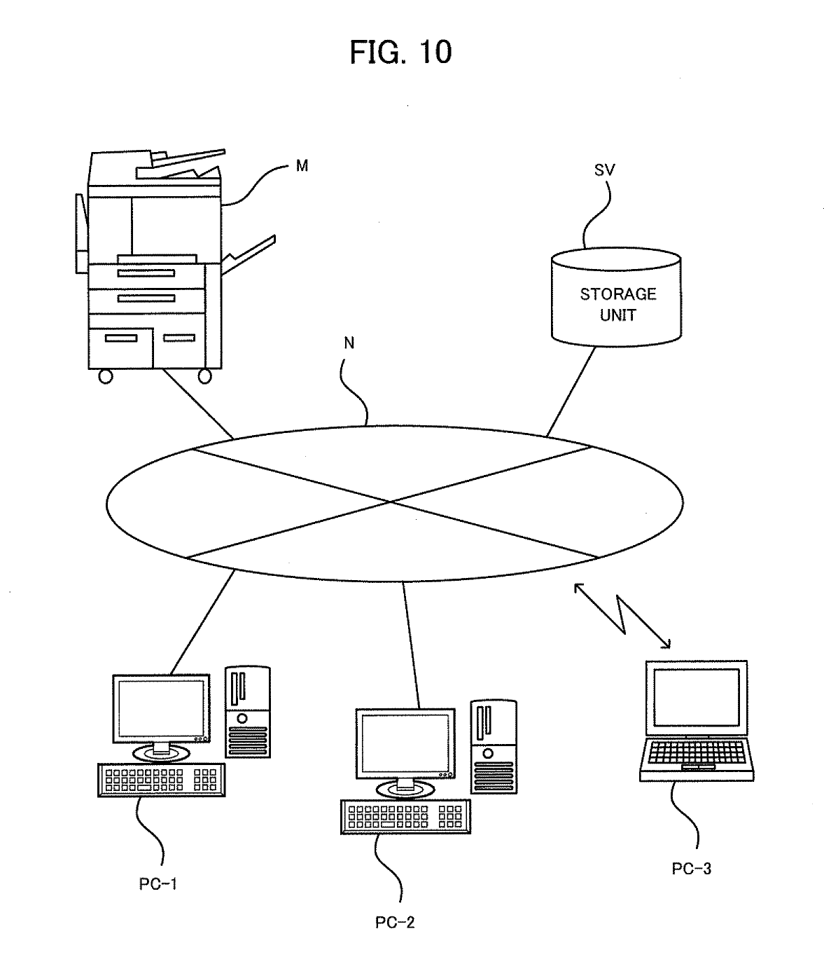

FIG. 10 illustrates a configuration of an information processing system according to the present exemplary embodiment. The information processing system has the storage unit SV connected via the communication line N and at least one of computers connected via the communication line N. The multi-function peripheral M, connected to the communication line N, performs processing to receive print information sent from the computers PC-1, PC-2 and PC-3, and print-output the print information on a medium such as a print sheet.

The computers PC-1, PC-2 and PC-3 are connected to the communication line N via a cable or radio communication. A printer driver to designate conditions for image formation performed in the multi-function peripheral M is installed in the computers PC-1, PC-2 and PC-3. The printer driver is stored in the storage unit SV, and delivered to the computers PC-1, PC-2 and PC-3 via the communication line N in accordance with necessity.

The information reading unit 11, the extraction unit 12 and the storage controller 13 shown in FIG. 6, are provided in at least one of the computers PC-1, PC-2 and PC-3. These units are realized by program processing performed on the computer. Further, the delivery unit 15 shown in FIG. 9 is also provided in accordance with necessity. The respective units may be provided in one computer or may be independently provided in plural computers and operate in cooperation via the communication line N. The operations of the respective units are the same as those described in the configurations of the above-described information processing apparatus. Note that the storage unit SV is not limited to a server type unit to transmit information via the communication line N and may be a storage device connected to the computers.

### <3. Information Processing Program>

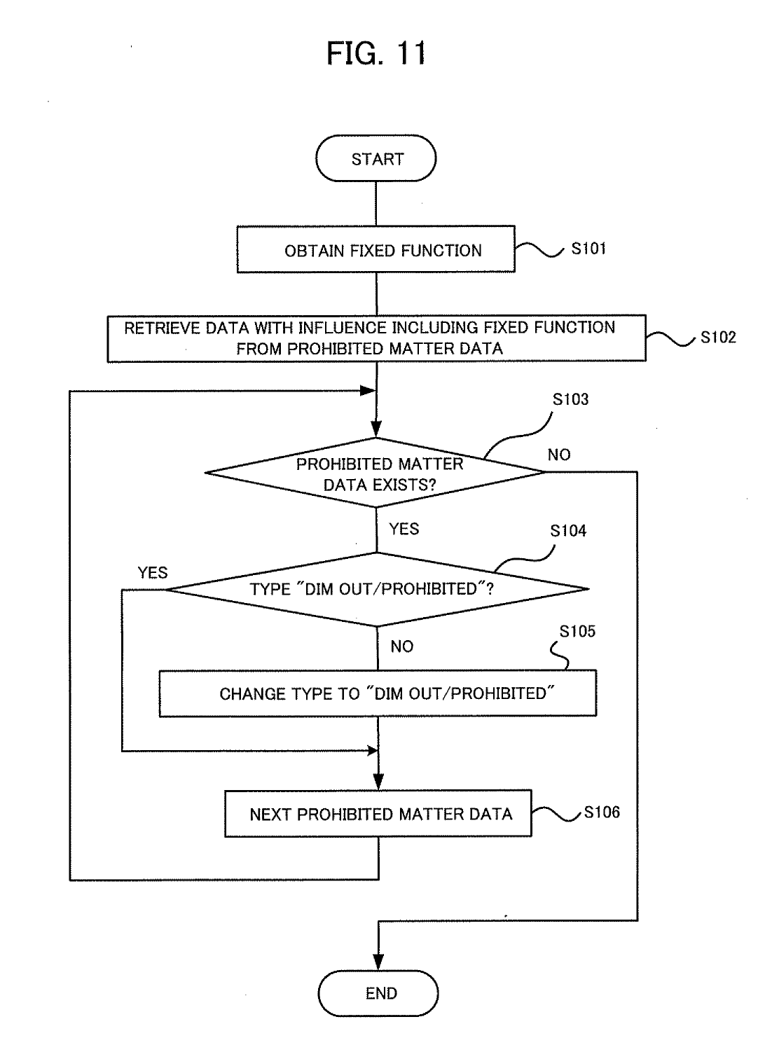

Next, an information processing program according to the present exemplary embodiment will be described. FIG. 11 is a flowchart showing an information processing program according to the present exemplary embodiment. The information processing program according to the present exemplary embodiment has steps performed by a computer. The computer has an arithmetic unit to execute the information processing program according to the present exemplary embodiment, a storage unit to store the program and various data, and an input/output unit. The computer may be a personal computer, or may be a device incorporated in an electronic device which can handle information such as an image forming apparatus (multi-function peripheral or the like) or a portable terminal. Further, the information processing program in the present exemplary embodiment may be stored on a storage medium such as a DC-ROM or may be delivered via a communication line.

In the following description, in the configuration shown in FIG. 10, the computer PC-1 executes the information processing program according to the present exemplary embodiment. First, the computer PC-1 performs processing to obtain fixed function information from the storage unit SV (step S101). The fixed function information means setting information and prohibited matter information used by the printer driver in the multi-function peripheral M.

Next, the computer PC-1 extracts data (prohibited matter data) regarding which a combination between the setting condition in image formation and the condition of a setting item designated by the user is disabled, from the obtained fixed function information (step S102). More particularly, the computer PC-1 retrieves data regarding which the “influence” item in the prohibited matter information (for example, see FIG. 5) becomes a state other than the set state. Then, the computer PC-1 performs the detected result for all the prohibited matter information (step S103).

Next, rewriting of all the prohibited matter data extracted in the retrieval is performed. More particularly, regarding an ID extracted as prohibited matter data, it is checked whether or not its “type” is “dim out/prohibited”. When the “type” is not “dim out/prohibited”, information rewriting to “dim out/prohibited” is performed (steps S104 to S105). This processing is repeated for all the retrieved IDs (step S106).

The above-described type rewriting in the information processing program may be performed upon item condition setting in use of the customize tool for the printer driver, or may be performed upon generation of new printer driver by the customize tool for all the combined information.

Further, it may be arranged such that, when restriction to prohibit single-sided printing in the “double sided” item is set with the customize tool, the above-described processing is performed, and the user interface of the customize tool is changed so as to reflect the restriction to prohibit the “double-sided printing unavailable paper size” in the corresponding “original size” item. By this processing, restriction item setting is performed while prohibited matter condition is added to the restriction setting.

In the prohibited matter data, as the “type” is automatically rewritten to “dim out/prohibited” by the above-described processing, it is not necessary for the user of the customize tool to grasp the prohibited matter data. That is, the user has only to set desired initial conditions, and even when the user of the printer driver sets the condition of a desired item, its initial condition is not invalidated.

### <4. Other Examples of Prohibited Matter Information>

### [Part 1]

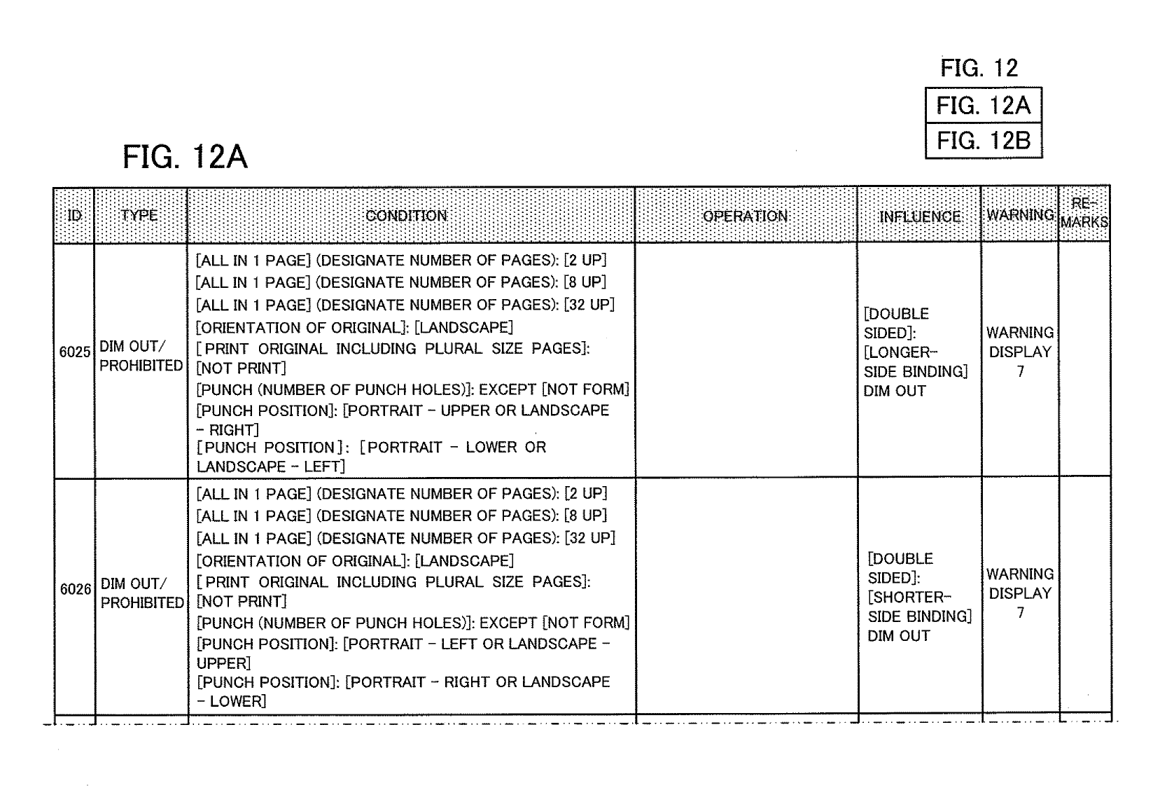

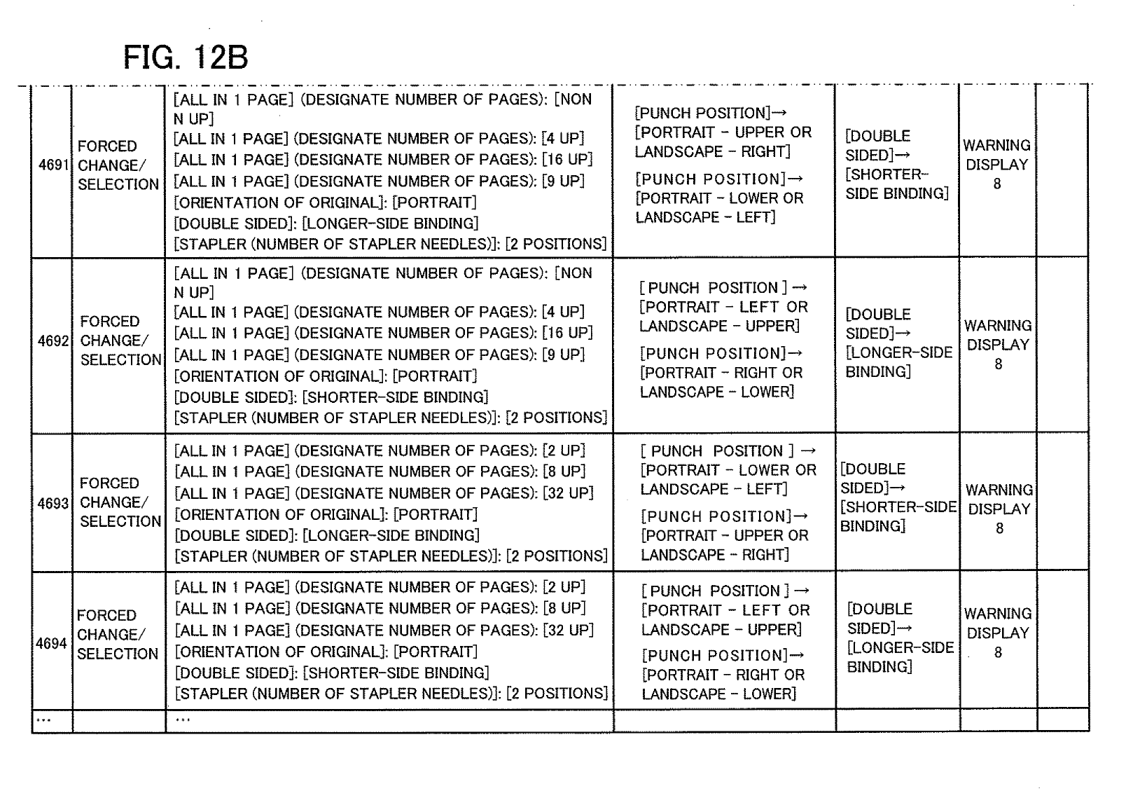

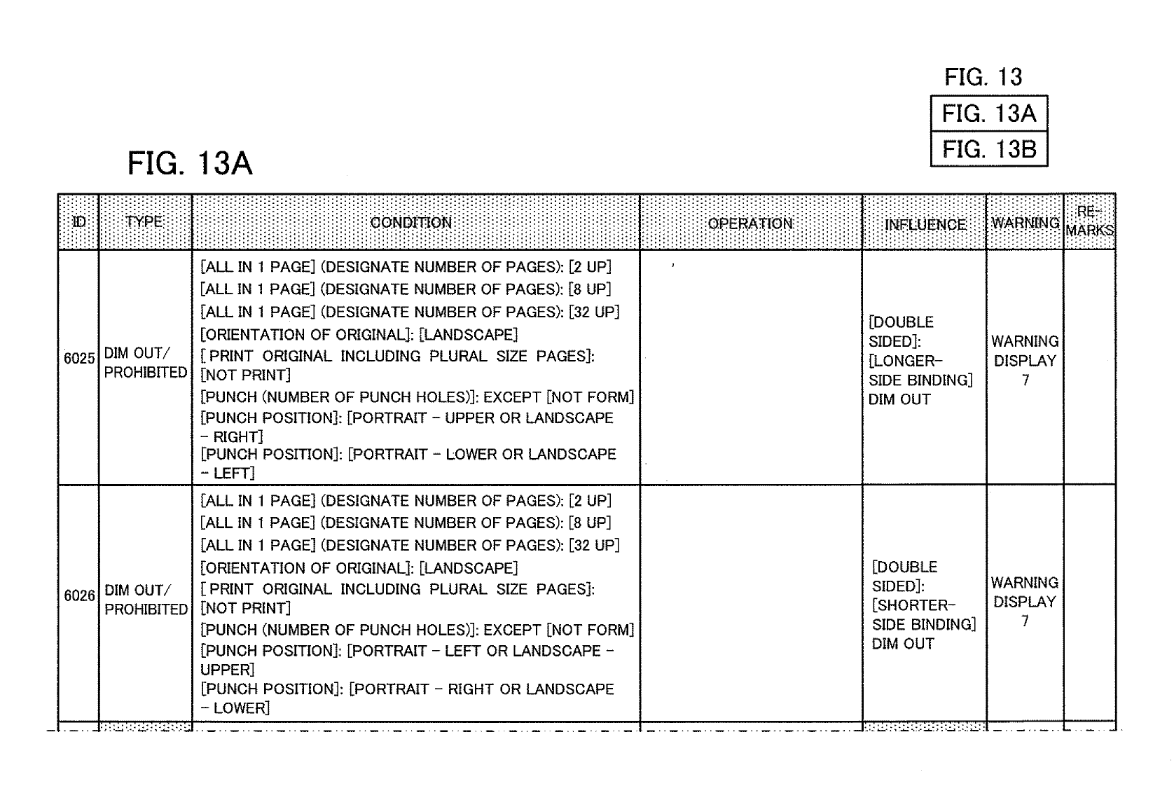

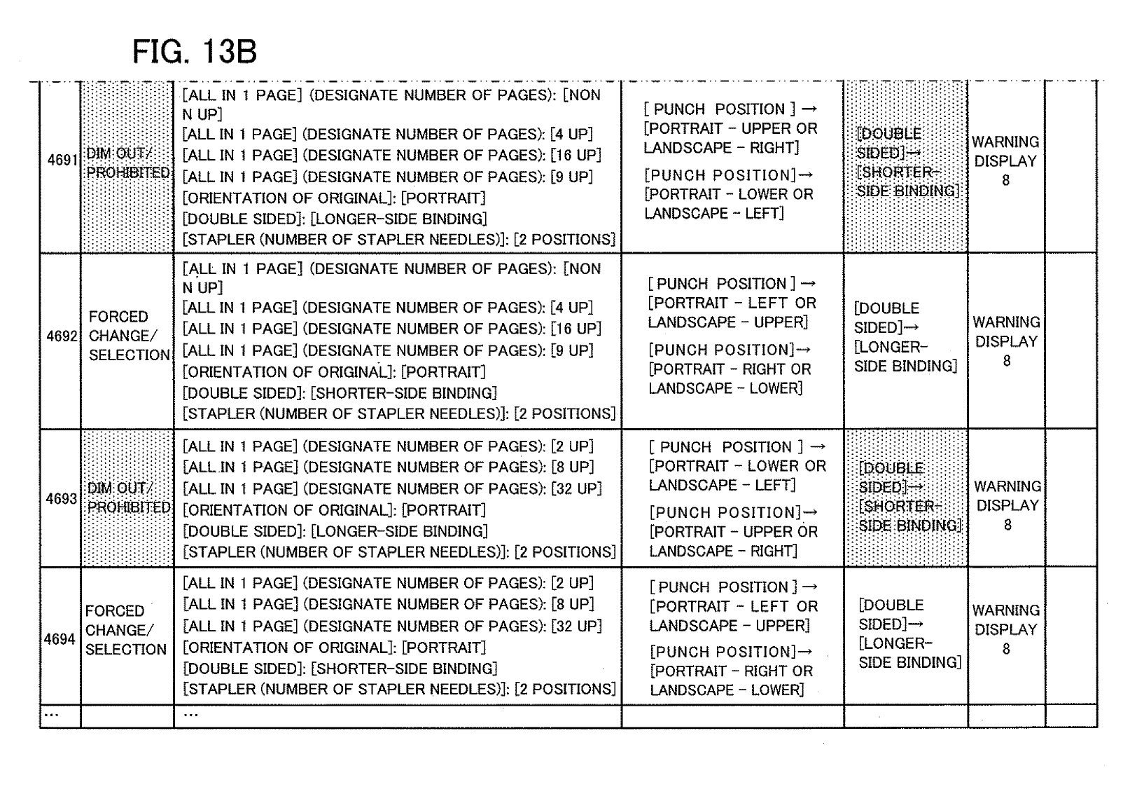

FIGS. 12 and 13 are tables explaining another example (part 1) of the prohibited matter information. FIG. 12 shows a state before the rewriting, and FIG. 13 shows a state after the rewriting. The prohibited matter information is information regarding a setting of double-sided printing and a setting of punch hole or stapler position. That is, the information indicating prohibited matter indicates that a punch hole or stapling cannot be set in a position which does not meet the setting of the double-sided printing.

For example, in the “condition” item, “all in one page” printing (so-called N-up) setting, “orientation of original” setting, “print/not print original including plural size pages” setting, form/not form “punch hole” setting, “punch position” setting, “stapler” setting and the like are made.

In the prohibited matter information for double-sided printing setting and punch hole or stapler position setting, in the “influence” item, an ID to change “double sided” to “shorter-side binding” is extracted. When the punch hole or stapler position in the case of “double sided” printing is previously set to “longer-side binding” (punching or stapling is performed on the longer-side side of the paper) and the “punch position” item is changed by the user's operation, the binding position is forcibly changed from the “longer-side binding” to the “shorter-side binding”.

Regarding the type of the ID extracted as above, “forced change” is rewritten to “dim out/prohibited”.

### [Part 2]

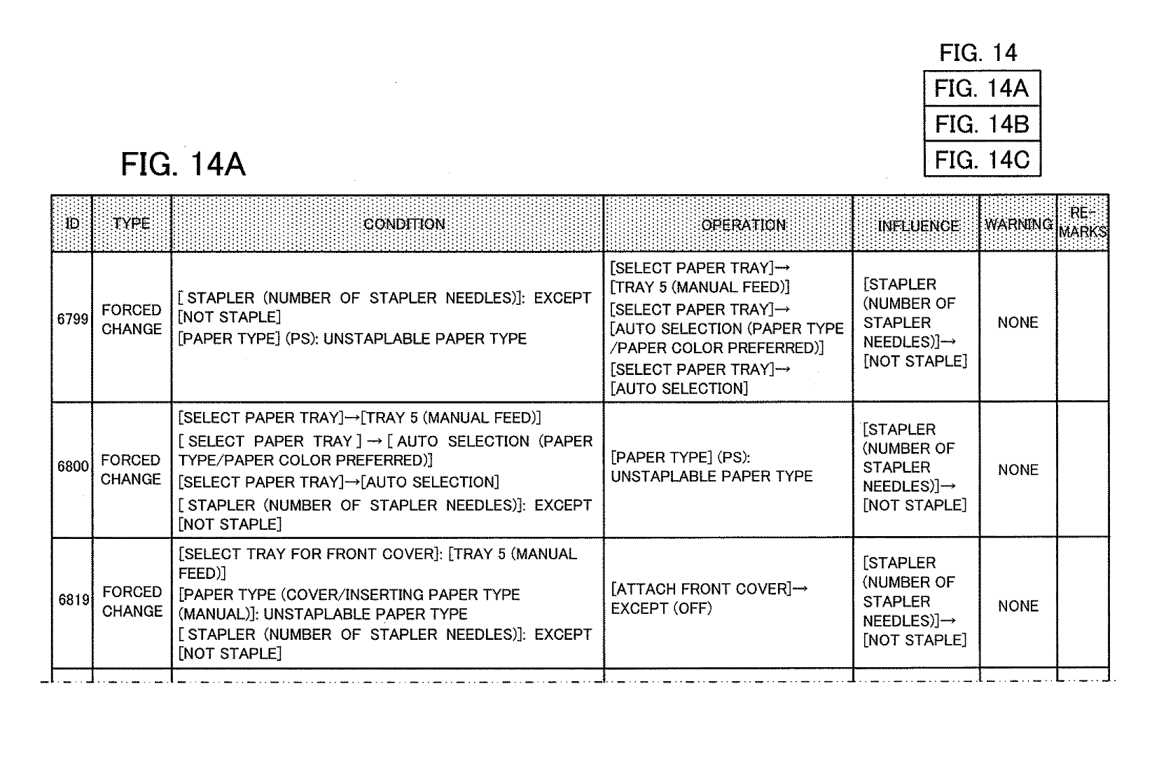

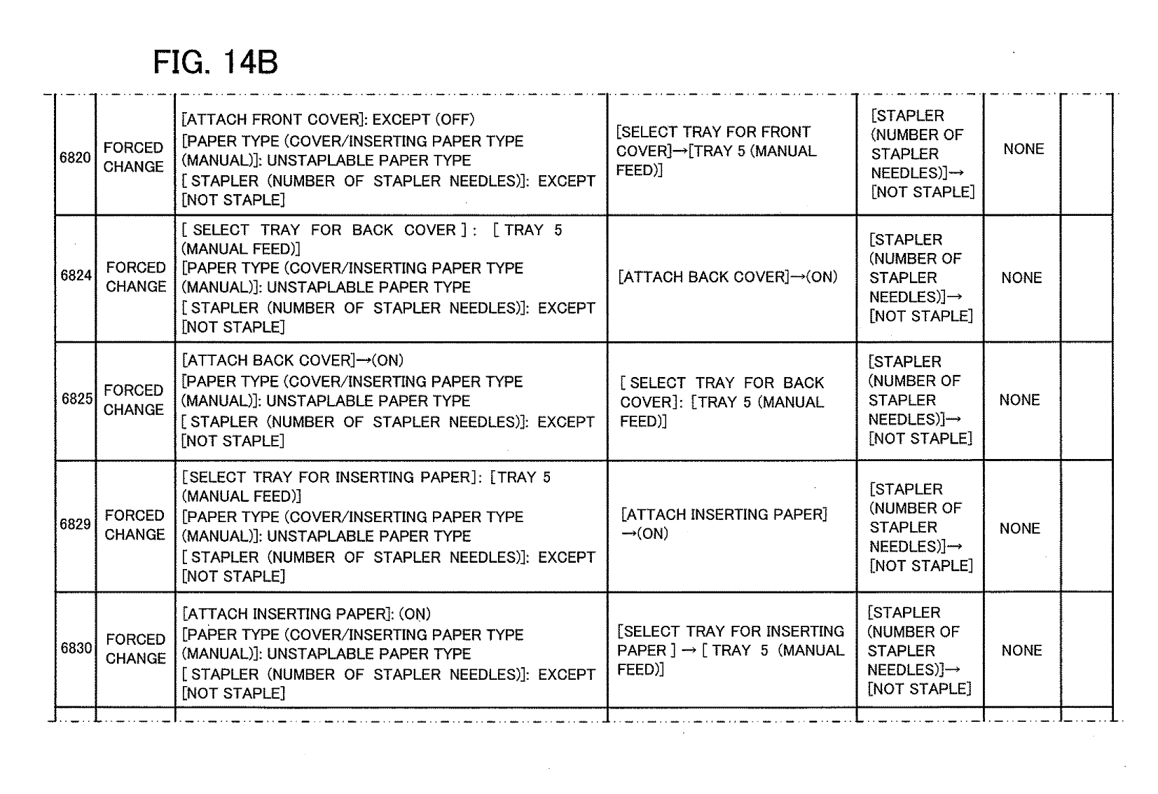

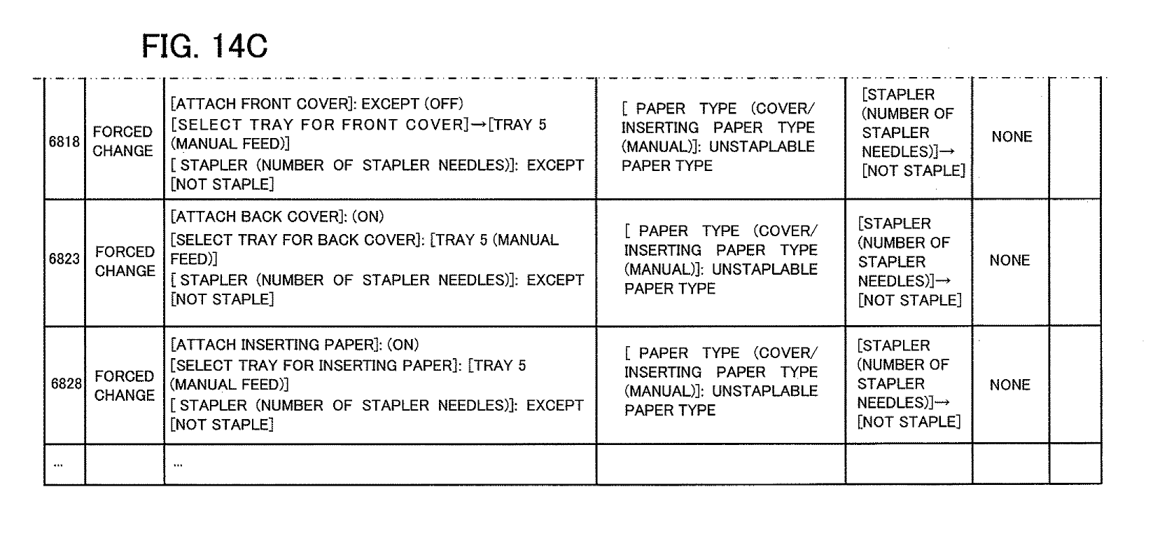

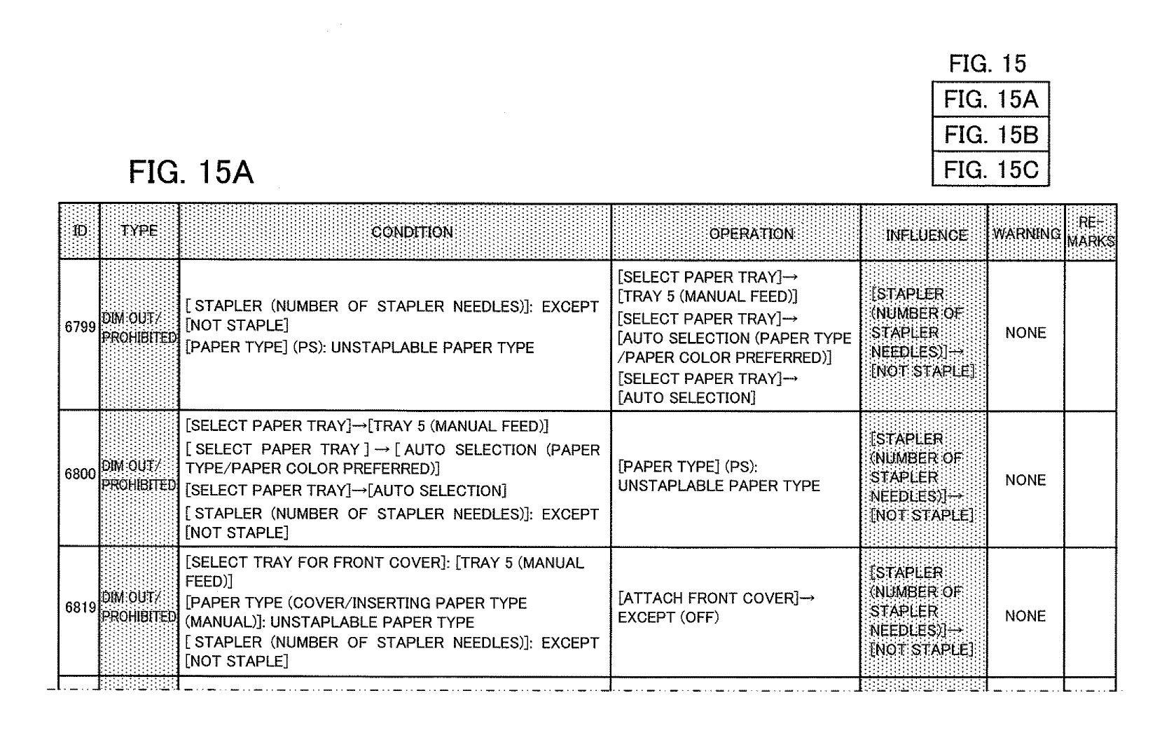

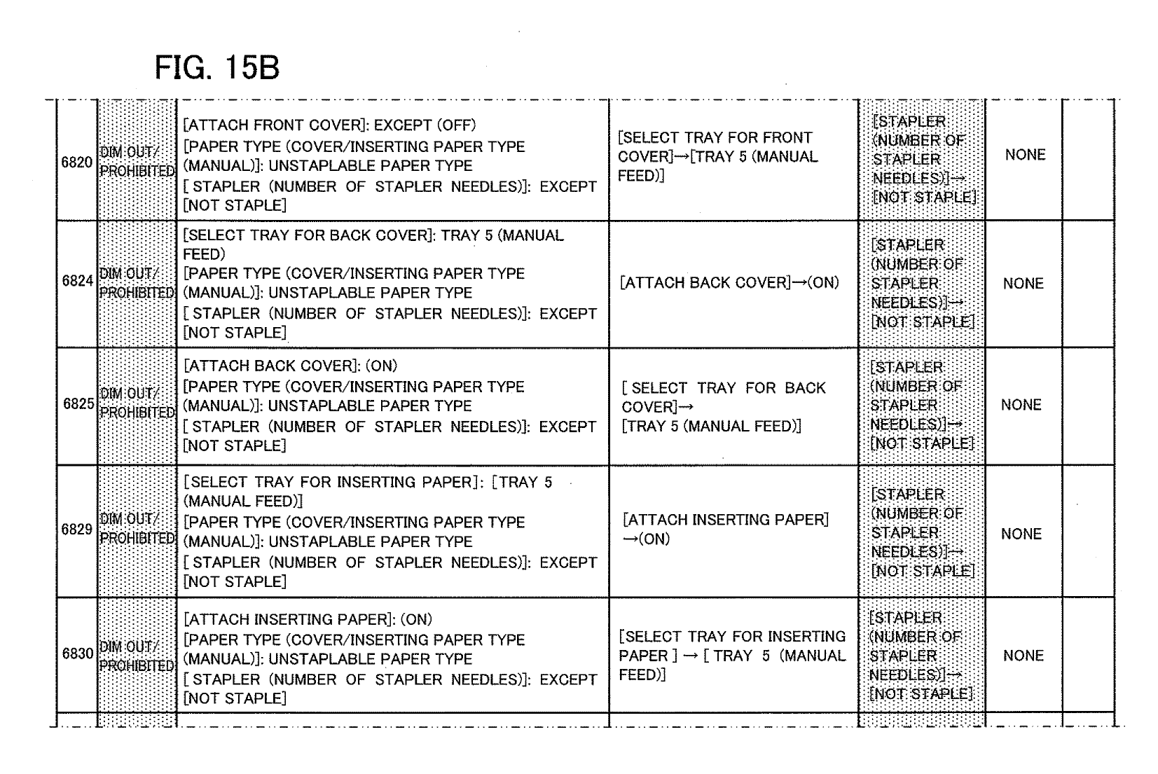

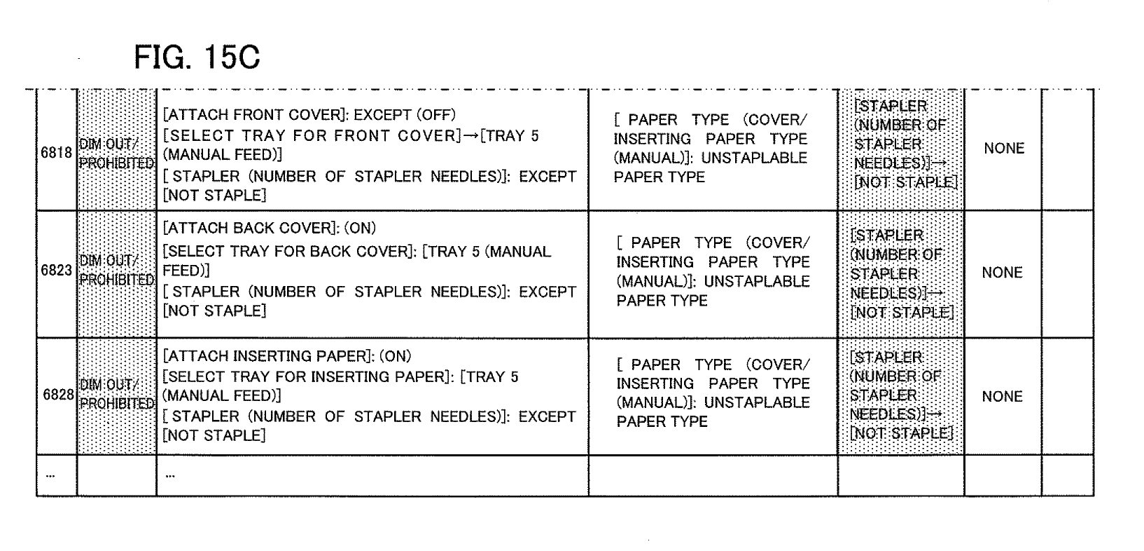

FIGS. 14 and 15 are tables explaining another example (part 2) of the prohibited matter information. FIG. 14 shows a state before the rewriting, and FIG. 15 shows a state after the rewriting. The prohibited matter information indicates setting and prohibited matter of stapler and paper type. That is, in the combinations of information, regarding designation of type of paper undischargeable to a finisher tray or designation of type of paper uncombined with stapling, the prohibited matter information indicates that designation of stapling cannot be made.

For example, in the “condition” item, the “stapler” setting, the “paper type” setting, the “paper tray” setting and the like are made.

In the prohibited matter information for the stapler and paper type settings, in the “influence” item, an ID to change “stapler (number of stapler needles)” to “not staple” is extracted. When the “stapler (number of stapler needles)” is previously set to “except ‘not staple’” and another item is changed by the user's operation, the setting is forcibly changed to “not staple”.

Regarding the type of the ID extracted as above, the information is rewritten from “forced change” to “dim out/prohibited”.

### [Part 3]

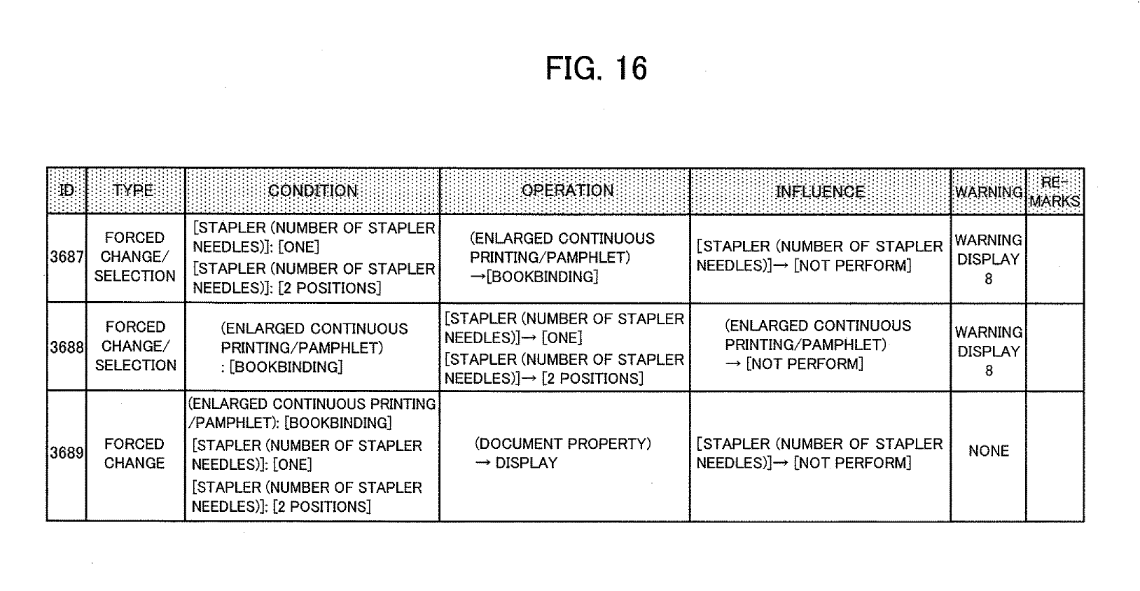

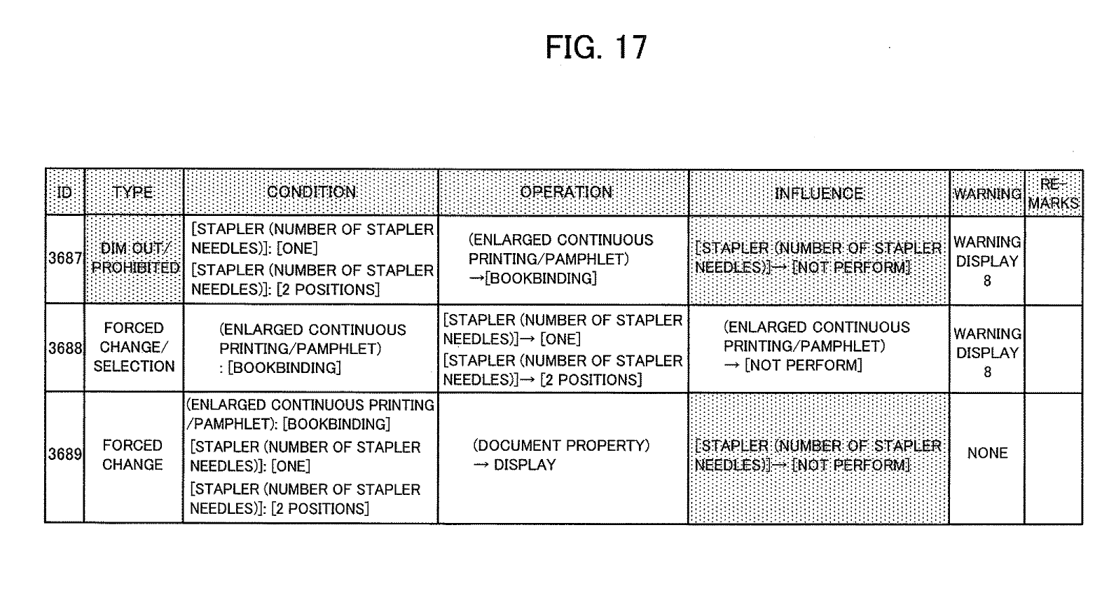

FIGS. 16 and 17 are tables explaining another example (part 3) of the prohibited matter information. FIG. 16 shows a state before the rewriting, and FIG. 17 shows a state after the rewriting. The prohibited matter information indicates pamphlet generation, stapler setting and a prohibited matter. That is, the prohibited matter information indicates that the pamphlet generation and stapling cannot be simultaneously designated.

For example, in the “condition” item, the “stapler” setting, execution/non-execution of “binding” setting and the like are made.

In the prohibited matter information regarding the pamphlet and stapler settings, in the “influence” item, an ID to change “stapler (number of stapler needles)” to “not staple” is extracted. When the “stapler (number of stapler needles)” is previously set to “except ‘not staple’” and another item is changed by the user's operation, the setting is forcibly changed to “not staple”.

Regarding the type of the ID extracted as above, as the type of ID with “operation” designated to binding, the information is rewritten from the “forced change” to the “dim out/prohibited”.

Note that in the above-described exemplary embodiment, mainly the customize tool for the printer driver is described; however, the present invention is not limited to the printer driver, and is applicable to a customize tool for a driver to operate various apparatuses such as a scanner driver and a facsimile driver.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for information processing, the process comprising:
reading, from a storage unit, setting information used in processing performed by an apparatus and prohibited matter information including at least a setting to avoid a prohibited matter at setting in the apparatus; and
extracting a setting to avoid the prohibited matter changeable regarding at least some of restricted setting information in the setting information read at the reading step, and making a setting not to perform the extracted setting.

2. The computer readable medium storing the program according to claim 1, wherein the setting not to perform the extracted setting is an instruction to produce a screen display to change the setting.

3. The computer readable medium storing the program according to claim 2, wherein the setting not to perform the extracted setting is an instruction to produce a display on the screen so as to prevent a user from changing the setting.

4. The computer readable medium storing the program according to claim 1, wherein the setting not to perform the extracted setting is an instruction to output a warning indicating that the setting cannot be changed.

5. The computer readable medium storing the program according to claim 2, wherein the setting not to perform the extracted setting is an instruction to output a warning indicating that the setting cannot be changed.

6. An information processing apparatus comprising:
an information reading unit that reads, from a storage unit, setting information used in processing performed by an apparatus and prohibited matter information including at least a setting to avoid a prohibited matter at setting in the apparatus;
an extraction unit that extracts a setting to avoid the prohibited matter changeable regarding at least some of restricted setting information in the setting information read by the information reading unit; and
a storage controller that performs control to store, into the storage unit, information indicating that the setting extracted by the extraction unit cannot be performed.

7. The information processing apparatus according to claim 6, further comprising an image forming unit that forms an image on a medium by use of setting information used in processing performed by the apparatus.

8. An information processing system comprising:
a storage unit that stores setting information used in processing performed by an apparatus and prohibited matter information including at least a setting to avoid a prohibited matter at setting in the apparatus;
an information reading unit that reads the setting information and the prohibited matter information stored in the storage unit via a communication line;
an extraction unit that extracts a setting to avoid the prohibited matter changeable regarding at least some of restricted setting information in the setting information read by the information reading unit; and
a storage controller that performs control to store, into the storage unit, information indicating that the setting extracted by the extraction unit cannot be performed.

9. The information processing system according to claim 8, further comprising a delivery unit that delivers the setting information and the prohibited matter information stored in the storage unit to a computer via the communication line.
